(19) United States
(12) Patent Application Publication
(10) Pub. No.: US 2003/0043124 A1
(43) Pub. Date: Mar. 6, 2003

(54) Image projection apparatus for terminals

(76) Inventors: Choong-Gil Kim, Seoul (KR); Back-gi Park, Seoul (KR)

Correspondence Address: BACON & THOMAS, PLLC, 625 SLATERS LANE, FOURTH FLOOR, ALEXANDRIA, VA, 22314

(21) Appl. No.: 09/942,540

(22) Filed: Aug. 31, 2001

(51) Int. Cl. G09G 5/00

(52) U.S. Cl. 345/204

(57) ABSTRACT

An image projection apparatus for terminals is disclosed. The image projection apparatus for terminals has a multifunctional display controller for converting an image data processed in the terminal into a displaying data with a predetermined standard. A transparent chip-type image reproducing means receives the displaying data to display it. A light source unit is arranged in the back of the image reproducing means for projecting a light beam onto the displayed image. An image enlarging means is arranged in front of the image reproducing means for optically projecting the image, projected forward by the image reproducing means using the light beam, to enlarge the image.

### BACKGROUND OF THE INVENTION

1. Field of the Invention

The present invention relates in general to an image projection apparatus, and more particularly to an image projection apparatus for terminals, connected to various kinds of terminals and arranged to project an image to be enlarged on a predetermined screen.

2. Description of the Prior Art

Recently, as electronics industries and data communication techniques have been rapidly developed, various kinds of characters and video information have been processed through terminals such as a desktop PC(Personal Computer) or notebook computer, and a mobile(or cellular) phone. Particularly, as information applications through the Internet have increased, information processing operations have been performed by accessing the Internet with the mobile phone as well as with the conventional desktop PC or notebook PC.

However, the display units of such conventional terminals have a problem that a monitor with a constant standard is connected to a terminal main body into a single body, thus limiting the viewing range of screen and its readability as described below.

For example, the CRT(Cathode Ray Tube) monitor, which is a display unit of the desktop PC, is problematic in that it is restricted in its screen size, and also has a large size and is heavy. The CRT monitor is also problematic in that its instalability is limited due to its requirement for a high driving voltage. Further, the CRT monitor is not suitable to carry because of its size, and its viewing range is restricted only to the front direction of the screen, due to the arrangement of the monitor screen to face a user.

Also, an LCD(Liquid Crystal Display) monitor, which is the display unit of a notebook PC, is problematic in that it is more restricted in its screen size than that of the CRT monitor. The LCD monitor is further problematic in that it is mounted in one body with a main body, such that it is restricted its viewing range only to the area in front of the screen.

Further, the LCD screen of a mobile phone is disadvantageous in that it is restricted in its viewing range and data display area within narrow limits due to a very small sized screen. The size of characters displayed on the LCD screen is accordingly small, thus decreasing the readability. Particularly, a recent Internet mobile phone having a Web browser for accessing the Internet has a problem that an area for displaying a unit image frame is restricted, thereby preventing the LCD screen from displaying an entire Internet Website or Web page.

Due to the above problems, the desktop PC, a notebook PC or a mobile phone may have a common problem that it is impossible for a large number of people to see the monitor at the same time, and also impossible to see the monitor from either side or the back side of the screen.

To solve the problems, a display unit such as an LCD projector connected to a desktop PC, a notebook PC and a mobile phone, has been provided to interface a terminal data memory for obtaining data therein, and project the data onto a screen through a TFT LCD and a lens. However, the LCD projector has a problem that it requires a bright light source for employing a long distance projection method, and it is not portable due to its large size.

### SUMMARY OF THE INVENTION

Therefore, the present invention has been made in view of the above problem, and it is an object of the present invention to provide an image projection apparatus for terminals, which projects an image processed in a terminal on an external screen, thus enlarging the image, in addition to expanding the viewing range and display area of the screen, and consequently improving its readability and shareability.

It is another object of the present invention to provide an image projection apparatus for terminals, which is preferably used with various kinds of terminals such as a desktop PC, a notebook PC, and a mobile phone, and which is easy to carry and accomplishes the recent trend of compactness, smallness and lightness.

In accordance with one aspect of the present invention, the above and other objects can be accomplished by the provision of an image projection apparatus connected to a conventional terminal for applying an image data with a predetermined standard processed in a central processing unit of the terminal to a monitor as a displaying data and displaying it on the monitor, comprising a multifunctional display controller for converting the image data processed in the terminal into a displaying data with a predetermined standard; a transparent chip-type image reproducing means for receiving the displaying data to display it; a light source unit arranged in the back of the image reproducing means for projecting a light beam onto the displayed image; and an image enlarging means arranged in the front of the image reproducing means for optically projecting the image, projected forward by the image reproducing means using the light beam, to enlarge the image.

According to the present invention, the image projection apparatus is internally or externally connected to a terminal which converts an image data processed within it or received from the outside into a displaying data and displays the data on its monitor.

In this case, if the image data processed in the terminal is converted into a displaying data with a predetermined standard by a multifunctional display controller and is displayed on a transparent image reproducing means, an image displayed on the image reproducing means is projected in a front direction by a light source unit, and is optically projected to be enlarged by an image enlarging means installed in front of the image reproducing means, thus allowing the enlarged image to be projected onto a screen.

Accordingly, the image data processed in the terminal is displayed on a fixed monitor integrated with the terminal into a single body through an image processing unit or a screen processing unit installed in a main body of the terminal. At the same time, or independently the image data can be projected onto a screen installed in an arbitrary place to be enlarged by changing the information display area and the size of the image data arbitrarily, according to the image projection apparatus of this invention. Thereby, the image projection apparatus may enlarge both the viewing range and the display area of the terminal, and improve an image readability for sharing the image data with another person according to an intention of a terminal operator.

Especially, if the image projection apparatus for terminals of this invention is internally or externally connected to an Internet mobile phone, the image displaying range can be enlarged with a predetermined standard and position, separate from an image displayed on a small-sized LCD screen attached to the mobile phone. Then, the entire screen display area is enlarged to a normal frame like a conventional desktop PC or notebook PC, thus allowing the user to use an Internet browser normally.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of an image projection apparatus for terminals according to the preferred embodiment of the present invention; and

FIG. 2 is a block diagram of the image projection apparatus used with an Internet mobile phone having an LCD screen and a Web browser.

### DETAILED DESCRIPTION OF THE PREFERRED EMBODIMENTS

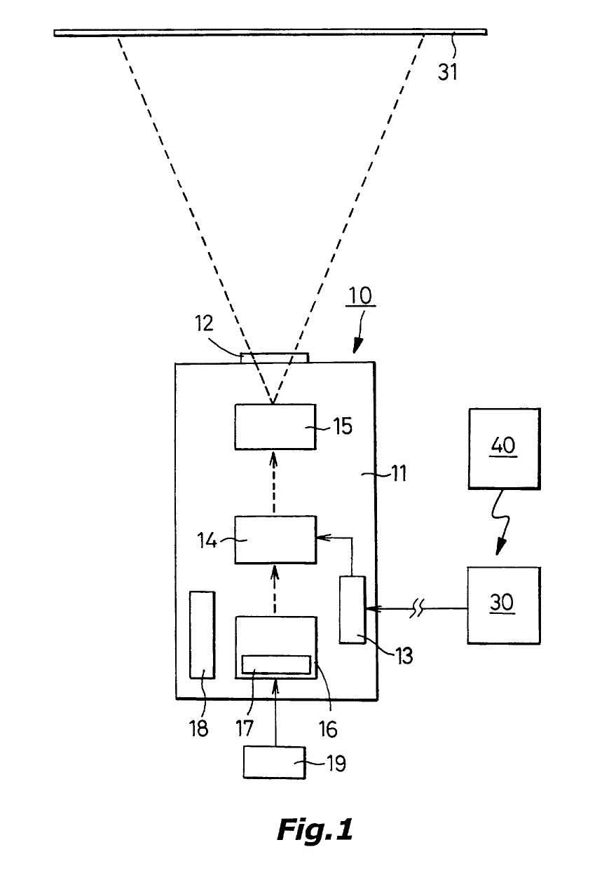

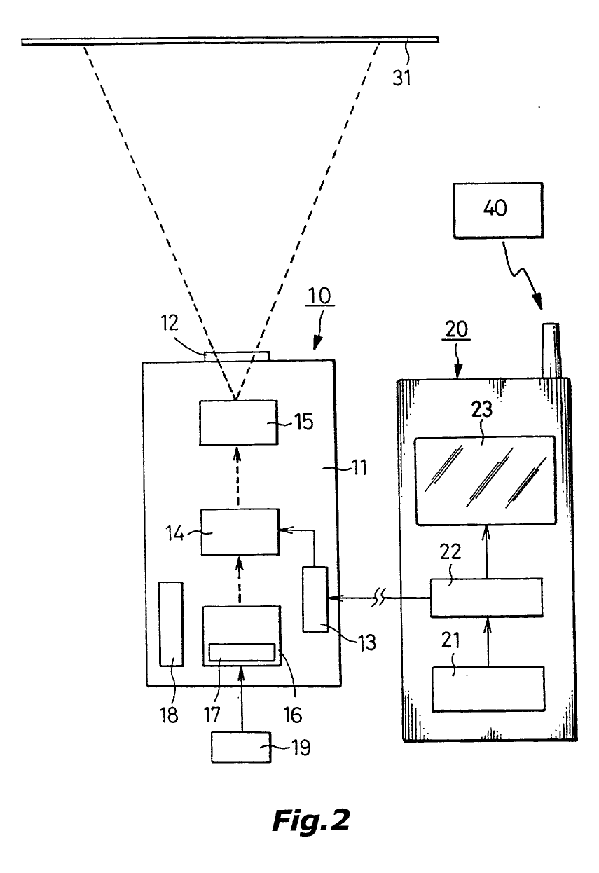

FIG. 1 is a block diagram of an image projection apparatus according to the preferred embodiment of this invention. FIG. 2 is a block diagram of the image projection apparatus used with an Internet mobile phone having an LCD screen and a Web browser.

Referring to FIG. 1 and FIG. 2, the image projection apparatus comprises a case 11 with a predetermined size for containing the elements of the image projection apparatus, a projection hole 12 formed at the front of the case 11, and a connection means(not shown) arranged on a PCB(printed circuit board) inside the case 11 for receiving data from the terminal 30.

The image projection apparatus further comprises a multifunctional display controller 13, an image reproducing means, an image enlarging means, and a light source unit as its main elements.

The multifunctional display controller 13 converts an image data received from the terminal 30 through the connection means into a displaying data with a predetermined standard.

The image reproducing means displays the displaying data from the controller 13. The image reproducing means includes a small-sized LCD panel 14 of the transparent chip type, arranged in opposite to the projection hole 12 inside the case 11, and connected to the controller 13 for receiving the image data from the controller 13 and displaying it.

The image enlarging means includes a group of enlarging optical lenses 15 arranged between the front of the LCD panel 14 and the projection hole 12, and is realized by a combination of a plurality of lenses for enlarging the image projected onto the LCD panel 14.

The light source unit 16 is arranged in the back of the LCD panel 14 for projecting a light beam onto the LCD panel 14. Preferably, the light source unit 16 may include a power supply connection unit 17 that connects the light source unit 16 to an external power supply 19. Typically, the power supply connection unit 17 may include an adapter, a wire and a plug. The specific construction and operation of the connection unit 17 is well known in the field and further explanation is thus not deemed necessary.

The image projection apparatus further comprises a cooling unit 18 for cooling the apparatus heated due to the presence of the light source unit 16. The cooling unit 18 has a general cooling element such as a cooling fan.

Referring to FIG. 2, the Internet mobile phone includes a transmission/reception unit for transmitting and receiving data to/from the server 40 in a wire or wireless manner. The mobile phone 20 further includes a data memory 21 for storing the image data received from the server 40, a character generating unit 22, and an LCD screen 23. In this case, the received image data is displayed on the LCD screen 23 through the character generating unit 22.

The reference numeral 31 of the drawings is a screen for displaying the image enlarged by the group of optical lenses 15. Here, any kinds of screens installed to form a plane perpendicular to the image projection apparatus 10 may be used.

Hereinafter, the operation of the image projection apparatus 10 used with the Internet mobile phone 20 is described in detail.

The multifunctional display controller 13 of the image projection apparatus 10 is connected to the data memory 21 of the Internet mobile phone 20 for receiving the image data through a connector or an RF transmission/reception unit.

In a normal operation of the Internet mobile phone 20, when the image data is applied to the data memory 21 from the server 40 in a wire or wireless manner, the image data is displayed on the LCD screen 23 attached on the mobile phone 20 through the character generating unit 22.

On the other hand, when a user wishes to project the image data inputted into the data memory 21 through the image projection apparatus to form an enlarged image in the normal operation of the mobile phone 20, preferably, an operation switch(not shown) is switched on to activate the image projection apparatus.

If the image projection apparatus is activated, the display controller 13 receives the image data stored in the data memory 21 of the mobile phone 20, converts the image data into the displaying data with a predetermined standard, and displays the displaying data on the LCD panel 14.

As described above, the image displayed on the LCD panel 14 is projected to the optical lens group 15 by the light beam emitted from the light source 16, and is projected to an outside through the projection hole 12. The projected image through the projection hole 12 is displayed on the external screen 31 as an enlarged image having a predetermined size.

In this regards, according to the operation of the image projection apparatus 10, the image data from the data memory 21 of the Internet mobile phone 20 can be independently displayed on the screen 31 through the apparatus 10 as a separate display unit, besides the LCD screen 23 installed in the mobile phone 20. Accordingly, the image data is converted into an image with an independent screen standard, thus enabling the image to be dually displayed on different displaying devices.

Subsequently, the image projection apparatus makes it possible to display an Internet Web page or Web browser, which cannot be displayed on the small-sized LCD screen 23 due to a readability of characters and images, on the external screen 31 with a frame of a predetermined standard, thus enabling the user to easily access the Internet normally.

As described above, if the image projection apparatus is independently realized outside the terminal, preferably the apparatus has a detachable supporter such as a camera supporter such that the projection hole 12 is fixed at a required height position so as to stably project the image without shaking.

The preferred embodiment is mainly described regarding the construction of the image projection apparatus externally connected to a mobile phone. However, it should be understood that the image projection apparatus of this invention might be installed within various kinds of terminals such as a desktop PC, a notebook PC, and an Internet mobile phone without affecting the functioning of this invention. Further, the image projection apparatus can be constructed independently from a terminal while having a detachable connecting means capable of connecting the apparatus to a terminal if necessary.

Further, if a projection distance of the apparatus is set to a short distance-type, the apparatus does not require a bright light source like a typical projector, thereby minimizing heat generated from the apparatus.

As apparent from the above description, the present invention provides an image projection apparatus for terminals, which can be portable while meeting the recent trend of compactness and smallness of a terminal, such that the apparatus can be internally or externally used with any kinds of fixed or portable terminals such as laptop computers or Internet mobile phones.

Further, when the present invention is applied to the fixed terminals, in addition to the portable terminals, the image data processed in the central processing units of the terminals, received from a server, or displayed by the data memories of the terminals is independently enlarged and reproduced on an arbitrary screen adjacent to the image projection apparatus with a predetermined display range or a caption size if necessary, regardless of the monitors connected to the main bodies of the terminals. Thereby, the apparatus allows a third person as well as a user of a corresponding terminal to share the screen by realizing another screen in parallel with its own monitor, such that the apparatus can be preferably used in various kinds of works requiring to share a screen such as a business, a service for public welfare, an education, and a presentation.

Particularly, if the present invention is adapted to an Internet mobile phone or a video phone, the image displayed on a small-sized LCD screen attached to the phone can be enlarged in a display area with an arbitrary frame, thus significantly promoting the Internet application without a restriction of the screen display area concerned to a Web browser, and increasing a convenience of the user due to an improvement in the screen shareability and readability.

Further, the present invention is advantageous in that the image data can be displayed on a predetermined screen without having a fixed monitor, thereby realizing a desktop PC free from a monitor while saving the installation area of the fixed monitor, and obtaining an economic effect due to the saving area.

Moreover, the present invention is advantageous in that it can be realized as a large-scaled screen with a high resolution according to the brightness of a light source, thereby allowing the present invention to be easily adapted to different fields using LCDs, such as an electric sign or an electric bulletin board.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An image projection apparatus connected to a conventional terminal for applying an image data with a predetermined standard processed in a central processing unit of the terminal to a monitor as a displaying data and displaying it on the monitor, comprising:
a multifunctional display controller for converting the image data processed in the terminal into a displaying data with a predetermined standard;
transparent chip-type image reproducing means for receiving the displaying data to display it;
a light source unit arranged in the back of the image reproducing means for projecting a light beam onto the displayed image; and
image enlarging means arranged in front of the image reproducing means for optically projecting the image, projected forward by the image reproducing means using the light beam, to enlarge the image.

2. The apparatus as set forth in claim 1, wherein the image projection apparatus is installed within an Internet mobile phone.

3. The apparatus as set forth in claim 1, wherein the image projection apparatus is installed within a desktop computer.

4. The apparatus as set forth in claim 1, wherein the image projection apparatus is installed within a notebook computer.

5. The apparatus as set forth in claim 1, wherein the image projection apparatus has data connecting means and detachable connecting means so as to be connected to the terminal.

6. An image projection apparatus connected to a conventional terminal for applying an image data with a predetermined standard processed in a central processing unit of the terminal to a monitor as a displaying data and displaying it on the monitor and installed in a case with a predetermined size, comprising:
a projection hole formed at the front of the case;
a multifunctional display controller for applying the image data through data connecting means from the terminal and converting the image data into a displaying data with a predetermined standard;
a transparent chip-type LCD panel arranged in opposite to the projection hole for displaying the displaying data therein;
a group of enlarging-optical lenses arranged in opposite to the projection hole in front of the LCD panel for optically projecting the image displayed on the LCD panel to be enlarged;
a light source arranged to emit a light beam projected on the back of the LCD panel.
power connection means for connecting a power supply to the light source; and
cooling means arranged inside the case for cooling the heated apparatus.
